(19) United States
(12) Patent Application Publication
(10) Pub. No.: US 2024/0239339 A1
(43) Pub. Date: Jul. 18, 2024

(54) VEHICLE DRIVING ASSISTANCE APPARATUS

(71) Applicant: TOYOTA JIDOSHA KABUSHIKI KAISHA, Toyota-shi (JP)

(72) Inventors: Hideki KAMATANI, Nagoya-shi (JP); Sui KURIHASHI, Toyota-shi (JP); Masayuki HOSOKAWA, Toyota-shi (JP)

(73) Assignee: TOYOTA JIDOSHA KABUSHIKI KAISHA, Toyota-shi (JP)

(21) Appl. No.: 18/390,796

(22) Filed: Dec. 20, 2023

(30) Foreign Application Priority Data
Jan. 13, 2023 (JP) 2023-003728

(51) Int. Cl. B60W 30/14; B60W 50/14

(52) U.S. Cl. CPC B60W 30/143; B60W 50/14; B60W 2540/215; B60W 2720/10

(57) ABSTRACT

A vehicle driving assistance apparatus executes a moving speed control of autonomously controlling a moving speed of a vehicle with respect to a set speed. When the moving speed control is being executed, and a consumed energy amount to move the vehicle by the moving speed control with respect to a first set speed which is the current set speed, is greater than the consumed energy amount to move the vehicle by the moving speed control with respect to a second set speed different from the first set speed, the vehicle driving assistance apparatus provides an operator of the vehicle with a proposal of changing the set speed from the first set speed to the second set speed. When the operator approves of the proposal, the vehicle driving assistance apparatus moves the vehicle by the moving speed control with respect to the second set speed.

### CROSS-REFERENCE TO RELATED APPLICATIONS

This application claims priority to Japanese patent application No. JP 2023-3728 filed on Jan. 13, 2023, the content of which is hereby incorporated by reference in its entirety.

### BACKGROUND

### Field

The present invention relates to a vehicle driving assistance apparatus.

### Description of the related art

There is known a vehicle driving assistance apparatus which executes a moving speed control of autonomously controlling an acceleration and a deceleration of an own vehicle so as to maintain a moving speed of the own vehicle at a set speed which corresponds to a predetermined moving speed. As this type of the vehicle driving assistance apparatus, there is also known a vehicle driving assistance apparatus which reduces the amount of energy consumed to move the own vehicle by setting an upper limit value of an acceleration rate of the own vehicle depending on the set speed and limiting the acceleration rate of the own vehicle to the upper limit value while the moving speed control is being executed (for example, refer to JP 2009-73390 A).

When the moving speed of the own vehicle varies, a moving resistance such as an air resistance imposed on the own vehicle also varies. Thus, when the set speed varies while the moving speed control is being executed, the moving resistance imposed on the own vehicle varies. In this regard, a consumed energy amount (i.e., the amount of energy consumed to move the own vehicle) may vary depending on the set speed. Therefore, in order to reduce the consumed energy amount, the set speed should be changed to one which can make the consumed energy amount smaller. In this regard, when the vehicle driving assistance apparatus voluntarily changes the set speed, a driver of the own vehicle may have a feeling of strangeness.

### SUMMARY

An object of the present invention is to provide a vehicle driving assistance apparatus which can reduce the amount of energy consumed to move the own vehicle by the moving speed control, preventing an operator including the driver of the own vehicle from having a feeling of strangeness.

A vehicle driving assistance apparatus according to the present invention comprises an electronic control unit. The electronic control unit is configured to execute a moving speed control of autonomously controlling a moving speed of an own vehicle with respect to a set speed which corresponds to a predetermined set moving speed. The vehicle driving assistance apparatus according to the present invention comprises a driving apparatus which generates a driving force to be applied to the own vehicle. The electronic control unit is configured to, when the electronic control unit is executing the moving speed control, and an amount of energy consumed to move the own vehicle by the moving speed control with respect to a first set speed which is the current set speed, is greater than an amount of energy consumed to move the own vehicle by the moving speed control with respect to a second set speed different from the first set speed, provide an operator of the own vehicle with a proposal of changing the set speed from the first set speed to the second set speed. The electronic control unit is configured to, when the operator approves of the proposal of changing the set speed from the first set speed to the second set speed, move the own vehicle by the moving speed control with respect to the second set speed.

When the moving speed of the own vehicle increases, a moving resistance of the own vehicle also increases. Therefore, a consumed energy amount (i.e., the amount of energy consumed to move the own vehicle) tends to increase. Thus, when the consumed energy amount can be reduced by changing the set speed while the moving speed control is being executed, there is an option of changing the set speed. In this regard, when the vehicle driving assistance apparatus voluntarily changes the set speed, the operator of the own vehicle may have a feeling of strangeness.

With the vehicle driving assistance apparatus according to the present invention, the proposal of changing the set speed is provided to the operator of the own vehicle when the amount of energy consumed to move the own vehicle can be reduced by changing the set speed while the moving speed control is being executed. Then, the set speed is changed when the operator approves of the proposal. Thus, the amount of energy consumed to move the own vehicle by the moving speed control can be reduced, preventing the operator from having a feeling of strangeness.

In the vehicle driving assistance apparatus according to an aspect of the present invention, the electronic control unit may be configured to, when there are a plurality of the second set speeds, propose the plurality of the second set speeds to the operator. In this aspect, the electronic control unit may be configured to move the own vehicle by the moving speed control with respect to the second set speed, of which the operator approves.

With the vehicle driving assistance apparatus according to this aspect of the present invention, when there are a plurality of the second set speeds, the plurality of the second set speeds are proposed. Thus, the operator can select the set speed which the operator desires.

In the vehicle driving assistance apparatus according to another aspect of the present invention, when the electronic control unit provides the operator with the proposal of changing the set speed from the first set speed to the second set speed, the electronic control unit may be configured to inform the operator of a time which is required for the own vehicle to arrive at a destination assuming that the set speed is changed from the first set speed to the second set speed.

With the vehicle driving assistance apparatus according to this aspect of the present invention, the operator can approve of the set speed, considering the time which will be taken to arrive at the destination.

In the vehicle driving assistance apparatus according to further another aspect of the present invention, the moving speed control may include a first moving speed control of maintaining the moving speed of the own vehicle at the set speed and a second moving speed control of alternately performing a power running and a coasting of the own vehicle while allowing the moving speed of the own vehicle to vary within a predetermined range including the set speed. In this aspect, when a predetermined control change condition becomes satisfied while the electronic control unit is executing the second moving speed control, the electronic control unit is configured to change the moving speed control from the second moving speed control to the first moving speed control, and inform the operator of a reason why the electronic control unit changes the moving speed control from the second moving speed control to the first moving speed control.

With the vehicle driving assistance apparatus according to this aspect of the present invention, when the moving speed control is changed from the second moving speed control to the first moving speed control, the reason why the moving speed control is changed from the second moving speed control to the first moving speed control is informed the operator. Thus, the vehicle driving assistance apparatus can prevent the operator from questioning changing the moving speed control.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle driving assistance apparatus according to an embodiment of the present invention.

FIG. 2A is a view which shows a scene where a preceding vehicle exists.

FIG. 2B is a view which shows a scene where the preceding vehicle does not exist.

FIG. 3 is a view which shows a flowchart of a routine executed by the vehicle driving assistance apparatus according to the embodiment of the present invention.

FIG. 4 is a view which shows a flowchart of a routine executed by the vehicle driving assistance apparatus according to the embodiment of the present invention.

FIG. 5 is a view which shows a flowchart of a routine executed by the vehicle driving assistance apparatus according to the embodiment of the present invention.

### DESCRIPTION OF THE EMBODIMENTS

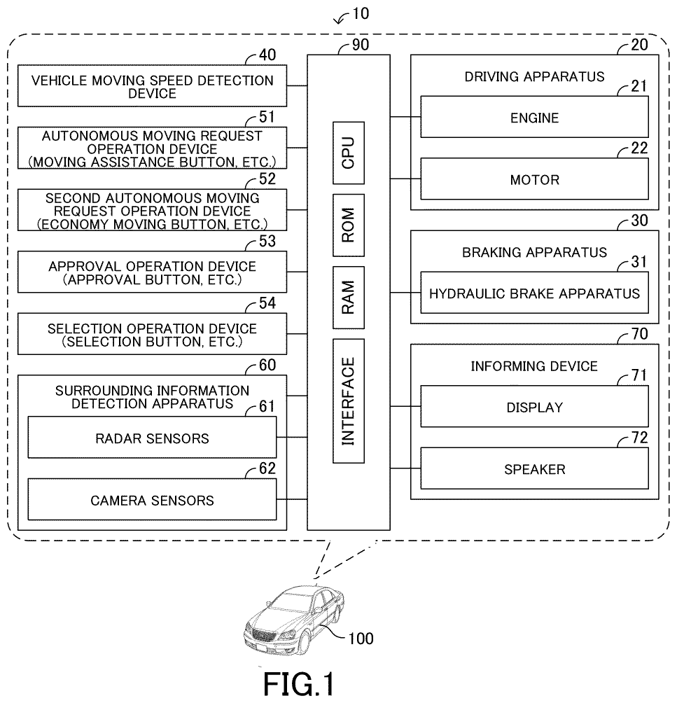

Below, a vehicle driving assistance apparatus according to an embodiment of the present invention will be described with reference to the drawings. FIG. 1 shows a vehicle driving assistance apparatus 10 according to the embodiment of the present invention. The vehicle driving assistance apparatus 10 is installed on an own vehicle 100. Hereinafter, the vehicle driving assistance apparatus 10 will be described with an example that an operator of the own vehicle 100 is a driver of the own vehicle 100, i.e., a person who is in the own vehicle 100 and directly drives the own vehicle 100.

In this regard, the operator of the own vehicle 100 may be a remote operator of the own vehicle 100, i.e., a person who is not in the own vehicle 100 and remotely drives the own vehicle 100. When the operator of the own vehicle 100 is the remote operator, the vehicle driving assistance apparatuses 10 are installed on the own vehicle 100 and a remote control facility provided outside the own vehicle 100 for remotely driving the own vehicle 100, respectively. In this case, functions of the vehicle driving assistance apparatus 10 described below are shared by the vehicle driving assistance apparatus 10 installed on the own vehicle 100 and the vehicle driving assistance apparatus 10 installed on the remote control facility.

As shown in FIG. 1, the vehicle driving assistance apparatus 10 includes an ECU (an electronic control unit) 90 as a control unit. The ECU 90 includes a microcomputer as a main component. The microcomputer includes a CPU, a ROM, a RAM and a storage medium such as a non-volatile memory, and an interface. The CPU is configured or programmed to realize various functions by executing instructions, or programs, or routines stored in the storage medium. In particular, in the present embodiment, the vehicle driving assistance apparatus 10 stores an autonomous moving program of executing an autonomous moving control described later in the storage medium.

The vehicle driving assistance apparatus 10 executes the autonomous moving control as an automatic driving control or an autonomous moving control. The autonomous moving control corresponds to a control of move the own vehicle 100 by autonomously controlling activations of a driving apparatus 20 and a braking apparatus 30 to accelerate or decelerate the own vehicle 100. In the present embodiment, the autonomous moving control includes an inter-vehicle distance control and a moving speed control. The driving apparatus 20 is an apparatus which generates a driving force to be applied to the own vehicle 100. In the present embodiment, the driving apparatus 20 includes an internal combustion engine 21 and an electric motor 22. Further, the braking apparatus 30 is an apparatus which applies a braking force to the own vehicle 100. In the present embodiment, the braking apparatus 30 includes a hydraulic braking apparatus 31.

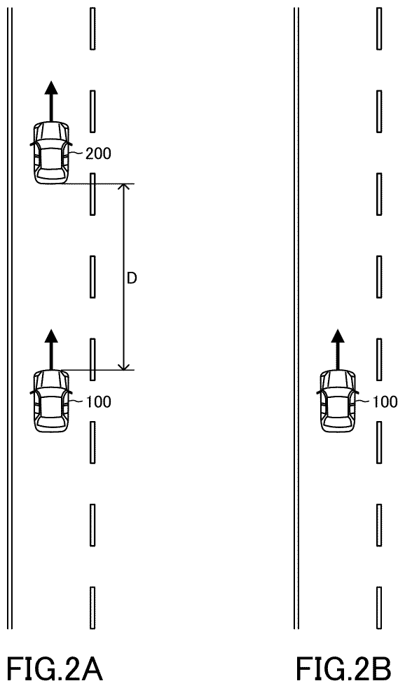

The inter-vehicle distance control is executed when a preceding vehicle 200 exists ahead of the own vehicle 100 as shown in FIG. 2A. The inter-vehicle distance control corresponds to a control of autonomously accelerating or decelerating the own vehicle 100 with respect to a target distance Dtgt. The preceding vehicle 200 is another vehicle which moves in front of the own vehicle 100 within a predetermined distance from the own vehicle 100. The vehicle driving assistance apparatus 10 detects the preceding vehicle 200 based on surrounding detection information IS described later. Further, the inter-vehicle distance Dtgt corresponds to an inter-vehicle distance D set by the driver as a control target used by the inter-vehicle distance control. The inter-vehicle distance D corresponds to a distance between the own vehicle 100 and the preceding vehicle 200. The vehicle driving assistance apparatus 10 acquires the inter-vehicle distance D based on the surrounding detection information IS described later.

On the other hand, the moving speed control is executed when the preceding vehicle 200 does not exist ahead of the own vehicle 100 as shown in FIG. 2B. The moving speed control corresponds to a control of autonomously controlling a moving speed of the own vehicle 100 (i.e., an own vehicle moving speed V) with respect to a set speed Vset. The set speed Vset corresponds to the moving speed of the own vehicle 100 (i.e., the own vehicle moving speed V) set previously by the driver as a control target used by the moving speed control. The vehicle driving assistance apparatus 10 acquires the own vehicle moving speed V by a vehicle speed detection device 40.

### Operations of Vehicle Driving Assistance Apparatus

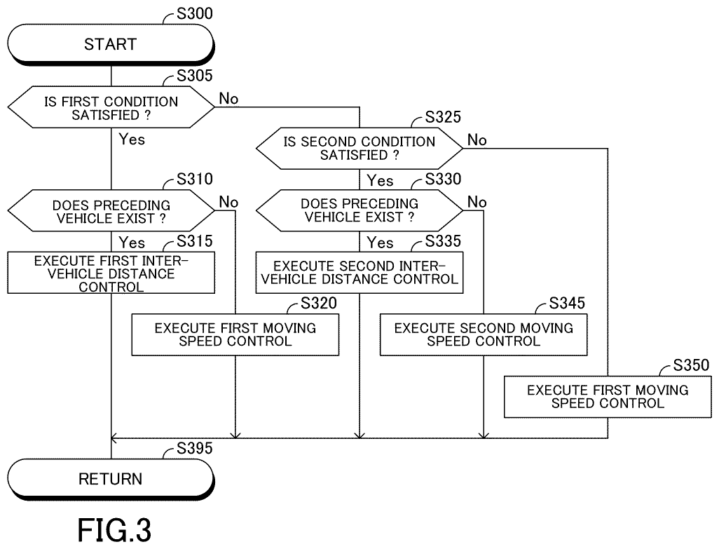

Next, operations of the vehicle driving assistance apparatus 10 will be described in detail. The vehicle driving assistance apparatus 10 executes the autonomous moving control by executing a routine shown in FIG. 3 at a predetermined calculation cycle.

At a predetermined point of time, the vehicle driving assistance apparatus 10 starts a process from a step S300 of the routine shown in FIG. 3 and proceeds with the process to a step S305 to determine whether a first condition C1 is satisfied. The first condition C1 corresponds to a condition that (i) an autonomous moving executable condition Cexe is satisfied, (ii) the autonomous moving control is required to be executed, and (iii) a second autonomous moving control (or an economy moving control) is not required to be executed. The autonomous moving executable condition Cexe corresponds to, for example, (i) a condition that a system required for an execution of the autonomous moving control is functioning normally, in particular, a surrounding information detection apparatus 60 is functioning normally, or (ii) a condition that a gradient of a road on which the own vehicle 100 is moving is not relatively great and thus it is determined that an execution of the second autonomous moving control is not preferable. It should be noted that the first condition C1 may not include a condition that the autonomous moving executable condition Cexe is satisfied.

The driver can request the vehicle driving assistance apparatus 10 to execute the autonomous moving control by operating an autonomous moving request operation device 51 such as a moving assistance button. Further, the driver can request the vehicle driving assistance apparatus 10 to execute the second autonomous moving control by operating a second autonomous moving request operation device 52 such as an economy moving button.

It should be noted that in the present embodiment, the second autonomous moving control includes a second inter-vehicle distance control and a second moving speed control, which will be described later.

When the vehicle driving assistance apparatus 10 determines “Yes” at the step S305, the vehicle driving assistance apparatus 10 proceeds with the process to a step S310 to determine whether the preceding vehicle 200 exists. The vehicle driving assistance apparatus 10 determines whether the preceding vehicle 200 exists based on the surrounding detection information IS.

The surrounding detection information IS corresponds to information provided from the surrounding information detection apparatus 60 installed on the own vehicle 100. In the present embodiment, the surrounding information detection apparatus 60 includes radar sensors 61 and camera sensors 62. The surrounding information detection apparatus 60 provides radar detection information (i.e., information around the own vehicle 100 acquired by the radar sensors 61) as the surrounding detection information IS to the vehicle driving assistance apparatus 10. In addition, the surrounding information detection apparatus 60 provides camera image information (i.e., image data on a situation around the own vehicle 100 acquired by the camera sensors 62) as the surrounding detection information IS to the vehicle driving assistance apparatus 10.

When the vehicle driving assistance apparatus 10 determines “Yes” at the step S310, the vehicle driving assistance apparatus 10 proceeds with the process to a step S315 to execute the first inter-vehicle distance control as the autonomous moving control. Then, the vehicle driving assistance apparatus 10 proceeds with the process to a step S395 to terminate executing this routine once. The first inter-vehicle distance control is the first autonomous moving control. The first inter-vehicle distance control corresponds to a control of autonomously controlling an acceleration and a deceleration of the own vehicle 100 so as to maintain the inter-vehicle distance D at the target distance Dtgt. Therefore, the first inter-vehicle distance control corresponds to a so-called following moving control or an adaptive cruise control. It should be noted that the vehicle driving assistance apparatus 10 may be configured to execute the first moving speed control when the own vehicle moving speed V increases and reaches the set speed Vset while the vehicle driving assistance apparatus 10 is executing the first inter-vehicle distance control.

On the other hand, when the vehicle driving assistance apparatus 10 determines “No” at the step S310, the vehicle driving assistance apparatus 10 proceeds with the process to a step S320 to execute the first moving speed control as the autonomous moving control. Then, the vehicle driving assistance apparatus 10 proceeds with the process to the step S395 to terminate executing this routine once. The first moving speed control is the first autonomous moving control. The first moving speed control corresponds to a control of autonomously controlling the acceleration and the deceleration of the own vehicle 100 so as to maintain the own vehicle moving speed V at the set speed Vset. Therefore, the first moving speed control corresponds to a so-called constant speed moving control or a cruise control.

In addition, when the vehicle driving assistance apparatus 10 determines “No” at the step S305, the vehicle driving assistance apparatus 10 proceeds with the process to a step S325 to determine whether a second condition C2 is satisfied. The second condition C2 corresponds to a condition that (i) the autonomous moving executable condition Cexe is satisfied, (ii) the autonomous moving control is required to be executed, and (iii) the second autonomous moving control (i.e., the economy moving control) is required to be executed. It should be noted that the second condition C2 may not include a condition that the autonomous moving executable condition Cexe is satisfied.

When the vehicle driving assistance apparatus 10 determines “Yes” at the step S325, the vehicle driving assistance apparatus 10 proceeds with the process to a step S330 to determine whether the preceding vehicle 200 exists. When the vehicle driving assistance apparatus 10 determines “Yes” at the step S330, the vehicle driving assistance apparatus 10 proceeds with the process to a step S335 to execute the second inter-vehicle distance control as the autonomous moving control. Then, the vehicle driving assistance apparatus 10 proceeds with the process to the step S395 to terminate executing this routine once.

The second inter-vehicle distance control corresponds to a control of autonomously controlling the acceleration and the deceleration of the own vehicle 100 so as to maintain the inter-vehicle distance D at a distance within a predetermined range or a predetermined distance range RD by (i) executing a coasting control of causing the own vehicle 100 to coast when the inter-vehicle distance D decreases and reaches a lower limit distance Dlower (i.e., a lower limit value of the predetermined distance range RD) and (ii) executing a power running control (or an optimum power running control) of moving the own vehicle 100 with power when the inter-vehicle distance D increases and reaches an upper limit distance Dupper (i.e., an upper limit value of the predetermined distance range RD). In the present embodiment, the predetermined distance range RD is set to a range which includes the target distance Dtgt.

Further, the optimum power running control corresponds to a control of controlling the activation of the driving apparatus 20 such that the driving force is output from the driving apparatus 20 with a highest energy efficiency. In particular, the optimum power running control corresponds to a control of operating the internal combustion engine 21 at an optimum operating point (or an operating point near the optimum operating point). In addition, the coasting control corresponds to a control of controlling the activation of the driving apparatus 20 such that the own vehicle 100 coasts.

It should be noted that the vehicle driving assistance apparatus 10 may be configured to execute the second moving speed control when the own vehicle moving speed V increases and reaches an upper limit speed Vupper described later while the vehicle driving assistance apparatus 10 is executing the second inter-vehicle distance control.

On the other hand, when the vehicle driving assistance apparatus 10 determines “No” at the step S330, the vehicle driving assistance apparatus 10 proceeds with the process to a step S345 to execute the second moving speed control as the autonomous moving control. Then, the vehicle driving assistance apparatus 10 proceeds with the process to the step S395 to terminate executing this routine once.

The second moving speed control corresponds to a control of autonomously controlling the acceleration and the deceleration of the own vehicle 100 so as to maintain the own vehicle moving speed V at a speed within a predetermined range or a predetermined speed range RV by starting to execute the coasting control when the own vehicle moving speed V increases and reaches an upper limit speed Vupper (i.e., an upper limit value of the predetermined speed range RV) and starting to execute the optimum power running control when the own vehicle moving speed V decreases and reaches a lower limit speed Vlower (i.e., a lower limit value of the predetermined speed range RV). In the present embodiment, the predetermined speed range RV is set to a range which includes the set speed Vset. Therefore, the second moving speed control corresponds to a control of alternately performing a power running and a coasting of the own vehicle 100 while allowing the own vehicle moving speed V to vary within the predetermined speed range RV (i.e., a predetermined range including the set speed Vset).

In addition, when the vehicle driving assistance apparatus 10 determines “No” at the step S325, the vehicle driving assistance apparatus 10 proceeds with the process to a step S350 to execute the first moving speed control. Next, the vehicle driving assistance apparatus 10 proceeds with the process to the step S395 to terminate executing this routine once. It should be noted that when the autonomous moving executable condition Cexe is not satisfied, the vehicle driving assistance apparatus 10 determines “No” at the step S325. In other words, when a predetermined control change condition is satisfied, the vehicle driving assistance apparatus 10 determines “No” at the step S325.

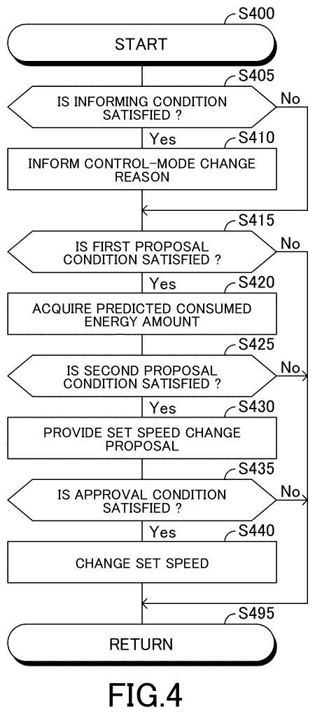

Further, the vehicle driving assistance apparatus 10 is configured to execute a routine shown in FIG. 4 at a predetermined calculation cycle. Therefore, at a predetermined point of time, the vehicle driving assistance apparatus 10 starts a process from a step S400 of the routine shown in FIG. 4 and proceeds with the process to a step S405 to determine whether an informing condition Cnot is satisfied. The informing condition Cnot corresponds to a condition that the autonomous moving control is changed from the second inter-vehicle distance control or the second moving speed control to the first moving speed control.

When the vehicle driving assistance apparatus 10 determines “Yes” at the step S405, the vehicle driving assistance apparatus 10 proceeds with the process to a step S410 to inform a control-mode change reason and then proceeds with the process to a step S415. The control-mode change reason corresponds to a reason why the autonomous moving control is changed from the second inter-vehicle distance control or the second moving speed control to the first moving speed control. The control-mode change reason is informed by displaying an image on a display 71 of an informing device 70 and/or outputting an announcement from a speaker 72 of the informing device 70.

On the other hand, when the vehicle driving assistance apparatus 10 determines “No” at the step S405, the vehicle driving assistance apparatus 10 directly proceeds with the process to the step S415.

When the vehicle driving assistance apparatus 10 proceeds with the process to the step S415, the vehicle driving assistance apparatus 10 determines whether a first proposal condition Cpps_1 is satisfied. The first proposal condition Cpps_1 corresponds to a condition that, for a predetermined period of time, (i) the autonomous moving control has not been changed, in particular, the autonomous moving control has not been changed from the second moving speed control to the second inter-vehicle distance control, and (ii) the set speed Vset has not been changed.

When the vehicle driving assistance apparatus 10 determines “Yes” at the step S415, the vehicle driving assistance apparatus 10 proceeds with the process to a step S420 to acquire a predicted consumed energy amount Econ_pre.

The predicted consumed energy amount Econ_pre corresponds to an amount of energy which is predicted to be consumed by the driving apparatus 20 when the own vehicle 100 is moved by the autonomous moving control using the moving speed which is different from the current set speed Vset (a first set speed) as the set speed Vset.

The predicted consumed energy amount Econ_pre can be calculated, for example, based on (i) the amount of energy actually consumed by the driving apparatus 20 when the own vehicle 100 is moved for a predetermined time by the autonomous moving control at the current set speed Vset, and (ii) a moving resistance of the own vehicle 100 when the own vehicle 100 is moved by the autonomous moving control at the set speed Vset which is different from the current set speed Vset.

In particular, a following method can be employed as a method of calculating the predicted consumed energy amount Econ_pre. That is, there can be employed a method of (i) acquiring a vehicle supplied energy amount, i.e., an amount of energy supplied from the driving apparatus 20 to the own vehicle 100 when the own vehicle 100 is moved for a predetermined time by the autonomous moving control at the current set speed Vset, (ii) acquiring the moving resistance of the own vehicle 100 when the own vehicle 100 is moved for the predetermined time by the autonomous moving control at the current set speed Vset, (iii) acquiring a driving system efficiency of the own vehicle 100 based on the acquired vehicle supplied energy amount and the acquired moving resistance of the own vehicle 100, and (iv) calculating as the predicted consumed energy amount Econ_pre, an amount of energy predicted to be consumed by the driving apparatus 20 when the own vehicle 100 is moved by the autonomous moving control at the set speed Vset different from the current set speed Vset by using the acquired driving system efficiency.

It should be noted that In the present embodiment, the driving system efficiency corresponds to a value acquired by dividing the moving resistance of the own vehicle 100 by the vehicle supplied energy amount. Further, the moving resistance is acquired, for example, by summing (i) a rolling resistance of the own vehicle 100, (ii) the air resistance of the own vehicle 100, (iii) a road gradient resistance (i.e., a resistance derived from the gradient of the road on which the own vehicle 100 is moving), and (iv) an acceleration resistance (a resistance derived from the acceleration of the own vehicle 100). It should be noted that the gradient of the road on which the own vehicle 100 is moving may be acquired by, for example, an acceleration rate sensor installed on the own vehicle 100, or may be acquired based on a current position of the own vehicle 100 acquired by GPS signals and map information.

Further, the air resistance is acquired by a following formula 1. In the following formula 1, “Rair” is the air resistance, “Cd” is a so-called Cd value (an air resistance coefficient), “ρair” is an air density, “S” is a front projected area of the own vehicle 100, and “V” is the own vehicle moving speed.

Rair=1/2Cd·ρair·S·V² (1)

Next, the vehicle driving assistance apparatus 10 proceeds with the process to a step S425 to determine whether a second proposal condition Cpps_2 is satisfied based on the predicted consumed energy amount Econ_pre. The second proposed implementation condition Cpps_2 corresponds to a condition that there is the set speed Vset (a second set speed) capable of executing the autonomous moving control with a consumed energy amount Econ smaller than the consumed energy amount Econ when the autonomous moving control is executed at the current set speed Vset.

When the vehicle driving assistance apparatus 10 determines “Yes” at the step S425, the vehicle driving assistance apparatus 10 proceeds with the process to a step S430 to perform a set speed change proposal. The set speed change proposal corresponds to a process of providing the driver with a proposal of changing the set speed Vset to a proposed set speed Vset_pps since there is the proposed set speed Vset_pps or second setting speed (i.e., the set speed Vset capable of reducing the consumed energy amount Econ). At this time, when there are a plurality of the proposed set speeds Vset_pps, a proposal of changing the set speed Vset to any one of the proposed set speeds Vset_pps, is provided to the driver by the set speed change proposal. It should be noted that the set speed change proposal is realized by displaying an image on the display 71 of the informing device 70 and/or outputting an announcement from the speaker 72 of the informing device 70.

Next, the vehicle driving assistance apparatus 10 proceeds with the process to a step S435 to determine whether the approval condition Capp is satisfied.

The approval condition Capp corresponds to a condition that the driver carries out an approval operation in response to the set speed change proposal. The approval operation corresponds to, for example, an operation carried out by the driver on an approval operation device 53 such as an approval button provided on a steering wheel of the own vehicle 100. It should be noted that when it is proposed that the set speed Vset is changed to any one of the plurality of the proposed set speeds Vset_pps at the step S430, the driver can carry out the approval operation after carrying out a selection operation of selecting any one of the plurality of the proposal set speeds Vset_pps. The selection operation corresponds to, for example, an operation carried out by the driver on a selection operation device 54 such as a selection button provided on the steering wheel of the own vehicle 100.

When the vehicle driving assistance apparatus 10 determines “Yes” at the step S435, the vehicle driving assistance apparatus 10 proceeds with the process to a step S440 to change the set speed Vset to the proposed set speed Vset_pps approved by the driver. Then, the vehicle driving assistance apparatus 10 proceeds with the process to a step S495 to terminate executing this routine once. As a result, the autonomous moving control is executed at the proposed set speed Vset_pps approved by the driver.

It should be noted that when the vehicle driving assistance apparatus 10 determines “No” at the step S415 or the step S425 or the step S435, the vehicle driving assistance apparatus 10 directly proceeds with the process to the step S495 to terminate executing this routine once.

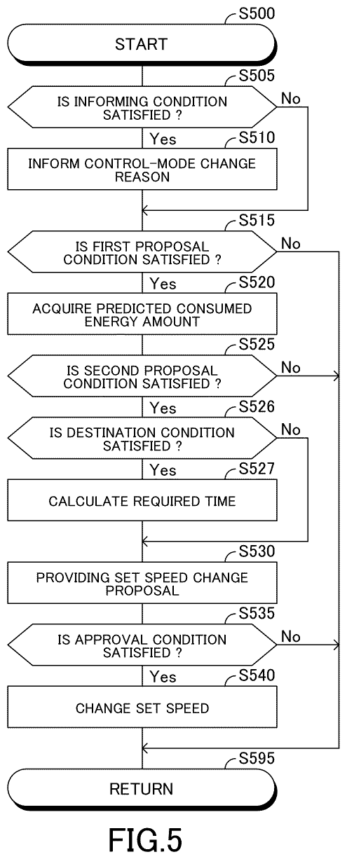

Further, the vehicle driving assistance apparatus 10 may be configured to execute a routine shown in FIG. 5 instead of the routine shown in FIG. 4. At a predetermined point of time, the vehicle driving assistance apparatus 10 starts a process from a step S500 of the routine shown in FIG. 5 and proceeds with the process to a step S505.

It should be noted that in the routine shown in FIG. 5, processes of a step S505 to a step S525 are the same as the processes of the step S405 to the step S425 of the routine shown in FIG. 4. Further, in the routine shown in FIG. 5, processes of a step S535 and a step S540 are the same as the processes of the step S435 and the step S440 of the routine shown in FIG. 4.

When the vehicle driving assistance apparatus 10 determines “Yes” at the step S525, the vehicle driving assistance apparatus 10 proceeds with the process to a step S526 to determine whether a destination condition Cdes is satisfied. The destination condition Cdes corresponds to a condition that a destination at which the own vehicle 100 is caused to arrives by a so-called navigation system, is set.

When the vehicle driving assistance apparatus 10 determines “Yes” at the step S526, the vehicle driving assistance apparatus 10 proceeds with the process to a step S527 to calculate a required time Treq. The required time Treq corresponds to a time required for the own vehicle 100 to arrive at the destination when the autonomous moving control is executed at the proposed set speed Vset_pps. At this time, when there are a plurality of the proposed set speeds Vset_pps, the vehicle driving assistance apparatus 10 calculates the required-time Treq for the respective proposed set speeds Vset_pps.

Next, the vehicle driving assistance apparatus 10 proceeds with the process to a step S530 to perform the set speed change proposal. According to the set speed change proposal here, since there is the proposed set speed Vset_pps, a proposal of changing the set speed Vset to the proposed set speed Vset_pps is provided to the driver, and the required time Treq is informed. At this time, when there are a plurality of the proposed set speeds Vset_pps, a proposal of changing the set speed Vset to any one of the proposed set speeds Vset_pps is provided to the driver by the set speed change proposal, and the required times Treq corresponding to the proposed set speeds Vset_pps, respectively are informed.

On the other hand, when the vehicle driving assistance apparatus 10 determines “No” at the step S526, the vehicle driving assistance apparatus 10 directly proceeds with the process to the step S530 to perform the set speed change proposal. According to the set speed change proposal here, since there is the proposed set speed Vset_pps, a proposal of changing the set speed Vset to the proposed set speed Vset_pps is provided to the driver. At this time, when there are a plurality of the proposed set speeds Vset_pps, a proposal of changing the set speed Vset to any one of the proposed set speeds Vset_pps is provided to the driver by the set speed change proposal.

The operations of the vehicle driving assistance apparatus 10 have been described.

### Advantages

When the own vehicle moving speed V increases, the consumed energy amount Econ tends to increase since the moving resistance of the own vehicle 100 increases. Therefore, there is an option to change the set speed Vset when the consumed energy amount Econ is reduced when the set speed Vset is changed while the moving speed control. In this regard, when the vehicle driving assistance apparatus 10 voluntarily changes the set speed Vset, the driver of the own vehicle 100 may have a feeling of strangeness.

With the vehicle driving assistance apparatus 10, the proposal of changing the set speed Vset is provided to the driver of the own vehicle 100 when the consumed energy amount Econ is reduced by changing the set speed Vset while the moving speed control is being executed. Then, when the driver approves of the proposal, the set speed Vset is changed. Thus, the consumed energy amount Econ by the moving speed control can be reduced, preventing the driver from having a feeling of strangeness.

It should be noted that the present invention is not limited to the aforementioned embodiments, and various modifications can be employed within the scope of the invention.

What is claimed is:

1. A vehicle driving assistance apparatus, comprising an electronic control unit which is configured to execute a moving speed control of autonomously controlling a moving speed of an own vehicle with respect to a set speed which corresponds to a predetermined set moving speed,
wherein the vehicle driving assistance apparatus comprises a driving apparatus which generates a driving force to be applied to the own vehicle, and
wherein the electronic control unit is configured to:
when the electronic control unit is executing the moving speed control, and an amount of energy consumed to move the own vehicle by the moving speed control with respect to a first set speed which is the current set speed, is greater than an amount of energy consumed to move the own vehicle by the moving speed control with respect to a second set speed different from the first set speed, provide an operator of the own vehicle with a proposal of changing the set speed from the first set speed to the second set speed; and
when the operator approves of the proposal of changing the set speed from the first set speed to the second set speed, move the own vehicle by the moving speed control with respect to the second set speed.

2. The vehicle driving assistance apparatus as claimed in claim 1,
wherein the electronic control unit is configured to:
when there are a plurality of the second set speeds, propose the plurality of the second set speeds to the operator; and
move the own vehicle by the moving speed control with respect to the second set speed, of which the operator approves.

3. The vehicle driving assistance apparatus as claimed in claim 1, wherein when the electronic control unit provides the operator with the proposal of changing the set speed from the first set speed to the second set speed, the electronic control unit is configured to inform the operator of a time which is required for the own vehicle to arrive at a destination assuming that the set speed is changed from the first set speed to the second set speed.

4. The vehicle driving assistance apparatus as claimed in claim 1,
wherein the moving speed control includes:
a first moving speed control of maintaining the moving speed of the own vehicle at the set speed; and
a second moving speed control of alternately performing a power running and a coasting of the own vehicle while allowing the moving speed of the own vehicle to vary within a predetermined range including the set speed, and
wherein when a predetermined control change condition becomes satisfied while the electronic control unit is executing the second moving speed control, the electronic control unit is configured to:
change the moving speed control from the second moving speed control to the first moving speed control; and
inform the operator of a reason why the electronic control unit changes the moving speed control from the second moving speed control to the first moving speed control.
